(19) United States
(12) Patent Application Publication
(10) Pub. No.: US 2015/0341515 A1
(43) Pub. Date: Nov. 26, 2015

(54) IMAGE SCANNER AND IMAGE FORMING APPARATUS

(71) Applicants: Yasunobu YOUDA, Kanagawa (JP); Koji HATAYAMA, Kanagawa (JP); Tatsuaki NAGANO, Kanagawa (JP); Yohei OSANAI, Kanagawa (JP); Satoshi NARAI, Tokyo (JP); Masafumi KISHI, Kanagawa (JP)

(72) Inventors: Yasunobu YOUDA, Kanagawa (JP); Koji HATAYAMA, Kanagawa (JP); Tatsuaki NAGANO, Kanagawa (JP); Yohei OSANAI, Kanagawa (JP); Satoshi NARAI, Tokyo (JP); Masafumi KISHI, Kanagawa (JP)

(73) Assignee: Ricoh Company, Ltd., Tokyo (JP)

(21) Appl. No.: 14/704,288

(22) Filed: May 5, 2015

(30) Foreign Application Priority Data
May 20, 2014 (JP) 2014-104466

(51) Int. Cl. H04N 1/00

(52) U.S. Cl. CPC H04N 1/00602

(57) ABSTRACT

An image scanner includes a primary conveyance roller to convey an original bearing an image in an original conveyance direction and an image reader disposed downstream from the primary conveyance roller in the original conveyance direction to read the image on the original. A moving original reading portion is disposed opposite the image reader. The image reader reads the image on the original through the moving original reading portion while the original moves over the moving original reading portion. A slope is disposed downstream from the moving original reading portion in the original conveyance direction. A spacer is interposed between the moving original reading portion and the slope in the original conveyance direction. A secondary conveyance roller has an original contact point to come into contact with the original. The original contact point is disposed opposite the spacer with an interval therebetween.

### CROSS-REFERENCE TO RELATED APPLICATION

This patent application is based on and claims priority pursuant to 35 U.S.C. §119 to Japanese Patent Application No. 2014-104466, filed on May 20, 2014, in the Japanese Patent Office, the entire disclosure of which is hereby incorporated by reference herein.

### BACKGROUND

1. Technical Field

Example embodiments generally relate to an image scanner and an image forming apparatus, and more particularly, to an image scanner for reading an image on an original and an image forming apparatus incorporating the image scanner.

2. Background Art

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such image forming apparatuses may include an image scanner incorporating an auto document feeder (ADF) that loads a plurality of originals and feeds the originals one by one to an image reader that reads an image on the original.

### SUMMARY

At least one embodiment provides a novel image scanner that includes a primary conveyance roller to convey an original bearing an image in an original conveyance direction and an image reader disposed downstream from the primary conveyance roller in the original conveyance direction to read the image on the original. A moving original reading portion is disposed opposite the image reader. The image reader reads the image on the original through the moving original reading portion while the original moves over the moving original reading portion. A slope is disposed downstream from the moving original reading portion in the original conveyance direction. A spacer is interposed between the moving original reading portion and the slope in the original conveyance direction. A secondary conveyance roller has an original contact point to come into contact with the original. The original contact point is disposed opposite the spacer with an interval therebetween.

At least one embodiment provides a novel image forming apparatus that includes an image forming device to form a toner image on a recording medium according to image data and an image scanner to read an image on an original to produce the image data to be sent to the image forming device. The image scanner includes a primary conveyance roller to convey the original bearing the image in an original conveyance direction and an image reader disposed downstream from the primary conveyance roller in the original conveyance direction to read the image on the original. A moving original reading portion is disposed opposite the image reader. The image reader reads the image on the original through the moving original reading portion while the original moves over the moving original reading portion. A slope is disposed downstream from the moving original reading portion in the original conveyance direction. A spacer is interposed between the moving original reading portion and the slope in the original conveyance direction. A secondary conveyance roller has an original contact point to come into contact with the original. The original contact point is disposed opposite the spacer with an interval therebetween.

Additional features and advantages of example embodiments will be more fully apparent from the following detailed description, the accompanying drawings, and the associated claims.

### BRIEF DESCRIPTION OF THE DRAWINGS

A more complete appreciation of example embodiments and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an example embodiment of the present disclosure;

FIG. 2 is a vertical sectional view of an image scanner incorporated in the image forming apparatus shown in FIG. 1;

FIG. 3 is a partial perspective view of an auto document feeder incorporated in the image scanner shown in FIG. 2;

FIG. 4 is a partial perspective view of the image scanner shown in FIG. 2 according to a first example embodiment of the present disclosure;

FIG. 5 is a partial vertical sectional view of the image scanner shown in FIG. 2;

FIG. 6A is a partial vertical sectional view of the image scanner shown in FIG. 2 illustrating an original conveyance path;

FIG. 6B is a partial vertical sectional view of the image scanner shown in FIG. 2 illustrating a card feeder;

FIG. 7A is a partial vertical sectional view of the image scanner shown in FIG. 6B illustrating a thin card coming into contact with a secondary conveyance roller;

FIG. 7B is a partial vertical sectional view of the image scanner shown in FIG. 7A illustrating the thin card exerted with an increased conveyance force from the secondary conveyance roller;

FIG. 8A is a partial vertical sectional view of the image scanner shown in FIG. 6B illustrating a thick card coming into contact with the secondary conveyance roller;

FIG. 8B is a partial vertical sectional view of the image scanner shown in FIG. 8A illustrating the thick card exerted with an increased conveyance force from the secondary conveyance roller;

FIG. 9 is a partial perspective view of an image scanner according to a second example embodiment of the present disclosure;

FIG. 10 is a partial vertical sectional view of the image scanner shown in FIG. 9;

FIG. 11 is a partial vertical sectional view of an image scanner according to a third example embodiment of the present disclosure;

FIG. 12 is a partial vertical sectional view of an image scanner as a variation of the image scanner shown in FIG. 11;

FIG. 13A is a partial vertical sectional view of an image scanner according to a fourth example embodiment of the present disclosure, illustrating a thin card conveyed therein; and

FIG. 13B is a partial vertical sectional view of the image scanner shown in FIG. 13A, illustrating a thick card conveyed therein.

The accompanying drawings are intended to depict example embodiments and should not be interpreted to limit the scope thereof. The accompanying drawings are not to be considered as drawn to scale unless explicitly noted.

### DETAILED DESCRIPTION

It will be understood that if an element or layer is referred to as being “on”, “against”, “connected to”, or “coupled to” another element or layer, then it can be directly on, against, connected or coupled to the other element or layer, or intervening elements or layers may be present. In contrast, if an element is referred to as being “directly on”, “directly connected to”, or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a term such as “below” can encompass both an orientation of above and below. The device may be otherwise oriented (rotated 90 degrees or at other orientations) and the spatially relative descriptors used herein are interpreted accordingly.

Although the terms first, second, and the like may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present disclosure.

The terminology used herein is for the purpose of describing particular embodiments only and is not intended to be limiting of the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

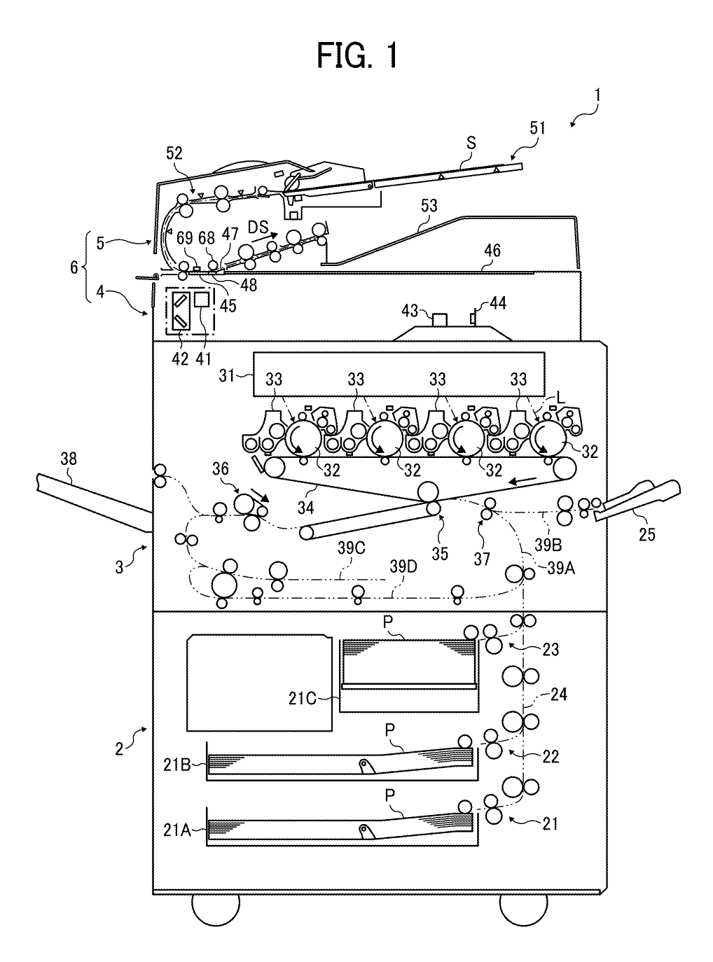

Referring now to the drawings, wherein like reference numerals designate identical or corresponding parts throughout the several views, particularly to FIG. 1, an image forming apparatus according to an example embodiment is explained.

The image forming apparatus may be a copier, a facsimile machine, a printer, a multifunction peripheral or a multifunction printer (MFP) having at least one of copying, printing, scanning, facsimile, and plotter functions, or the like. According to this example embodiment, the image forming apparatus is an MFP that forms color and monochrome toner images on recording media by electrophotography.

With reference to FIG. 1, a description is provided of a construction of an MFP 1 serving as the image forming apparatus.

FIG. 1 is a schematic vertical sectional view of the MFP 1. The MFP 1 forms monochrome and color toner images by electrophotography. Alternatively, the image forming apparatus may form images by other methods, for example, an inkjet method.

As shown in FIG. 1, the MFP 1 includes a sheet feeding device 2, an image forming device 3, an image reader 4, and an auto document feeder (ADF) 5. The image reader 4 and the ADF 5 constitute an image scanner 6.

A detailed description is now given of a construction of the sheet feeding device 2. The sheet feeding device 2 includes three paper trays 21A, 21B, and 21C being layered vertically and loading recording media P (e.g., sheets) of different sizes, respectively. The sheet feeding device 2 includes sheet feeders 21, 22, and 23 that pick up and feed an uppermost recording medium P from the paper trays 21A, 21B, and 21C, respectively. The sheet feeding device 2 further includes a sheet feeding path 24 provided with a plurality of rollers that conveys the recording medium P conveyed from one of the sheet feeders 21, 22, and 23 to a given image forming position inside the image forming device 3.

A detailed description is now given of a construction of the image forming device 3.

The image forming device 3 includes an exposure device 31, a plurality of photoconductive drums 32, a plurality of developing devices 33 replenished with toners in different colors, that is, cyan, magenta, yellow, and black toners, respectively, a transfer belt 34, a secondary transfer device 35, and a fixing device 36.

The exposure device 31 exposes each of the photoconductive drums 32 with a laser beam L according to image data created by the image scanner 6, forming an electrostatic latent image on each of the photoconductive drums 32. The developing devices 33 supply the cyan, magenta, yellow, and black toners to the electrostatic latent images on the photoconductive drums 32, developing the electrostatic latent images into cyan, magenta, yellow, and black toner images, respectively. The cyan, magenta, yellow, and black toner images formed on the photoconductive drums 32 are primarily transferred onto the transfer belt 34. The secondary transfer device 35 secondarily transfers the cyan, magenta, yellow, and black toner images from the transfer belt 34 onto the recording medium P conveyed from the sheet feeding device 2, thus forming a color toner image on the recording medium P. The fixing device 36 melts and fixes the color toner image on the recording medium P.

The image forming device 3 further includes a conveyance path 39A through which the recording medium P conveyed from the sheet feeding path 24 of the sheet feeding device 2 is further conveyed to a stack tray 38. For example, the conveyance path 39A is provided with a registration roller pair 37 that conveys the recording medium P conveyed from the sheet feeding path 24 to the secondary transfer device 35 in synchronism with the cyan, magenta, yellow, and black toner images superimposed on the transfer belt 34. The conveyance path 39A conveys the recording medium P through the registration roller pair 37, the secondary transfer device 35, and the fixing device 36 to the stack tray 38.

The image forming device 3 further includes a bypass tray 25 that loads a plurality of recording media and a bypass conveyance path 39B that conveys a recording medium from the bypass tray 25 to the conveyance path 39A and delivers the recording medium at a position upstream from the registration roller pair 37 in a recording medium conveyance direction.

The image forming device 3 further includes a switchback conveyance path 39C and a reverse conveyance path 39D. During duplex printing, the recording medium P bearing the toner image on a front side thereof is conveyed to the registration roller pair 37 through the switchback conveyance path 39C and the reverse conveyance path 39D.

A detailed description is now given of a construction of the image reader 4.

The image reader 4 serving as a primary image reader includes a first carriage 41 mounting a light source and a minor, a second carriage 42 mounting a mirror, and an image forming lens 43, and an imaging device 44.

When the image reader 4 reads an image on an original S conveyed by the ADF 5, the first carriage 41 moves to a reading position immediately below and disposed opposite a slit glass 45. While the first carriage 41 stops at the reading position, the image reader 4 reads the image on the original S. As the original S passes over an upper face of the slit glass 45, the light source mounted on the first carriage 41 emits light onto the original S through the slit glass 45. The light reflected by the original S is deflected by the minors mounted on the first carriage 41 and the second carriage 42, respectively, and enters the image forming lens 43 to form an image in the imaging device 44 that produces image data. When the first carriage 41 is at the reading position, the image on the original S is conjugated with the imaging device 44 with respect to the image forming lens 43.

Conversely, when the image reader 4 reads an image on an original S placed on an exposure glass 46 and positioned by a stopper 47, the first carriage 41 and the second carriage 42 move horizontally in FIG. 1 in a sub-scanning direction. As the first carriage 41 and the second carriage 42 move, the light source mounted on the first carriage 41 emits light onto the original S. The mirrors mounted on the first carriage 41 and the second carriage 42 deflect the light reflected by the original S. The deflected light enters the image forming lens 43 that forms an image in the imaging device 44 that produces image data.

A main controller (e.g., a processor), that is, a central processing unit (CPU) provided with a random-access memory (RAM) and a read-only memory (ROM), for example, is operatively connected to the sheet feeding device 2, the image forming device 3, and the image reader 4 to control driving or the like thereof.

According to this example embodiment, the upper face of the slit glass 45 is leveled with an upper face of the exposure glass 46 such that they are on an identical plane. A spacer 48 extending in a main scanning direction, that is, a proximal-distal direction in FIG. 1, is interposed between the slit glass 45 and the stopper 47 in an original conveyance direction DS. A detailed description of a configuration of the spacer 48 is deferred. Alternatively, the spacer 48 may be coupled with the stopper 47.

A detailed description is now given of a construction of the ADF 5. The ADF 5 includes an original tray 51, serving as an original support, where at least one original S is placed, an original conveyer 52 including a plurality of rollers, and an output tray 53 that stacks originals S after image reading performed by the image reader 4. The original tray 51 and the output tray 53 overlap at least partially in a state in which the original tray 51 is spaced apart from the output tray 53, downsizing the ADF 5. The ADF 5 separates an uppermost original S from other originals S of a plurality of originals S placed on the original tray 51. The original conveyer 52 conveys the uppermost original S onto the slit glass 45. After the image reader 4 reads an image on the original S while the original S passes over the slit glass 45, the ADF 5 ejects the original S onto the output tray 53. The ADF 5 is secured to the image reader 4 through an open-close mechanism (e.g., a hinge) such that the ADF 5 is lifted and lowered or opened and closed with respect to the image reader 4.

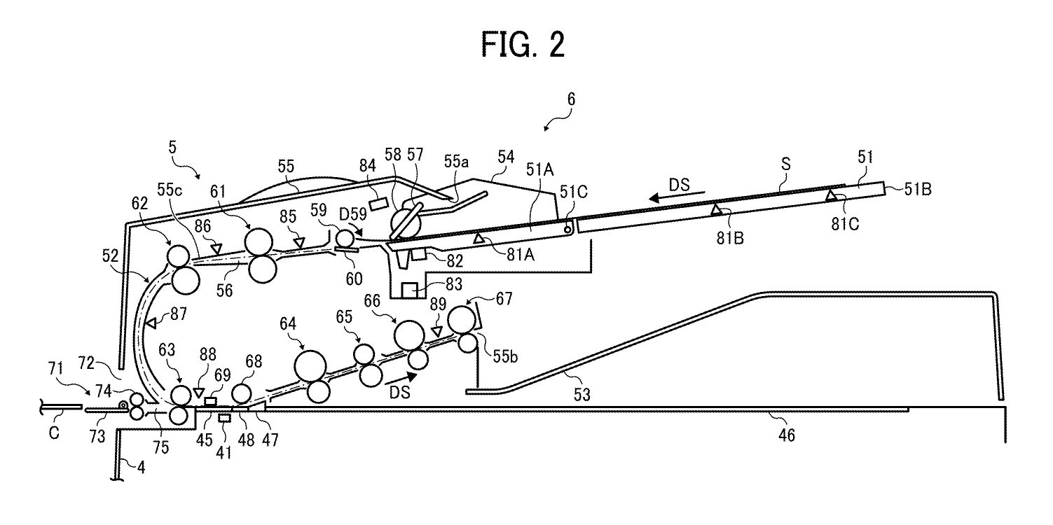

FIG. 2 is a vertical sectional view of the image scanner 6 illustrating the ADF 5. The original tray 51 is tilted with respect to the image reader 4 such that a leading end of the original tray 51 contacting a leading edge of the original S in the original conveyance direction DS and being directed to the original conveyer 52 is lower than a trailing end of the original tray 51 contacting a trailing edge of the original S in the original conveyance direction DS. That is, the trailing end of the original tray 51 is directed upward. The original tray 51 is divided into a leading original tray 51A and a trailing original tray 51B. The leading original tray 51A is pivotable about a shaft 51C such that a leading end of the leading original tray 51A in the original conveyance direction DS is directed downward according to the thickness of a sheaf of originals S. The original tray 51 mounts a side guide plate 54 that comes into contact with the original S to define the position of the original S in a direction perpendicular to the original conveyance direction DS directed to the original conveyer 52.

While one lateral edge, that is, a first lateral edge, of the original S in the direction perpendicular to the original conveyance direction DS contacts one lateral edge, that is, a first lateral edge, of the original tray 51, the side guide plate 54 is movable relative to another lateral edge, that is, a second lateral edge, of the original S. For example, the side guide plate 54 is disposed at another lateral edge, that is, a second lateral edge, of the original tray 51 in the direction perpendicular to the original conveyance direction DS such that the side guide plate 54 is slidable over the original tray 51 to move closer to and away from the first lateral edge of the original tray 51 in the direction perpendicular to the original conveyance direction DS. Accordingly, the smaller the size of the original S placed on the original tray 51 is, the farther the side guide plate 54 displaces toward the first lateral edge of the original tray 51 to come into contact with the original S. Alternatively, the original tray 51 may mount a pair of side guide plates 54 relatively movable to come closer to and separate away from each other so that the original S is centered on the original tray 51 in the direction perpendicular to the original conveyance direction DS.

A cover 55 that is openable and closable covers at least an upper part of the original conveyer 52. The cover 55 includes an inlet 55a disposed opposite and above a downstream end of the original tray 51 in the original conveyance direction DS to guide the leading edge of the original S to an inside of the cover 55. The cover 55 covers an upper part of the leading end of the leading original tray 51A such that the leading end of the leading original tray 51A is situated downstream from the inlet 55a in the original conveyance direction DS. The original conveyer 52 includes an original conveyance path 56 defined by a rib 55c or the like mounted on the cover 55 or the like in a span from the inlet 55a to an outlet 55b above the output tray 53. The cover 55 mounts a card feeder 71 on a side wall of the cover 55 constituting a side wall of the MFP 1.

The original conveyer 52 further includes a set feeler 57 disposed at an upstream end of the original conveyer 52 in proximity to the inlet 55a and above the leading end of the leading original tray 51A. The set feeler 57 pivots as the original S comes into contact with the set feeler 57. The original conveyer 52 further includes a pickup roller 58 disposed in proximity to and downstream from the inlet 55a in the original conveyance direction DS, a feed roller 59, and a separation plate 60 disposed opposite the feed roller 59 via the original conveyance path 56. The pickup roller 58, the feed roller 59, and the separation plate 60 constitute an original feeder.

The pickup roller 58 picks up an uppermost original S or several uppermost originals S from the plurality of originals S loaded on the original tray 51 at a contact position where the pickup roller 58 comes into contact with the uppermost original S.

The feed roller 59 is rotatable clockwise in FIG. 2 in a rotation direction D59 to feed the original S in the original conveyance direction DS. If the pickup roller 58 feeds the plurality of originals S to the feed roller 59, the separation plate 60 exerts a resistance against underneath originals S other than the uppermost original S of the plurality of originals S fed by the feed roller 59 rotating in the rotation direction D59, thus preventing feeding of the underneath originals S. Alternatively, the feed roller 59 may be a feed belt. The separation plate 60 may be a roller rotatable in a direction counter to the rotation direction D59 of the feed roller 59 or the feed belt.

The original conveyer 52 includes a plurality of conveyance roller pairs 61 to 67, each of which is constructed of two rollers disposed opposite each other via the original conveyance path 56 to convey the original S while nipping the original S. A secondary conveyance roller 68 is interposed between the conveyance roller pairs 63 and 64 in the original conveyance direction DS and disposed opposite the spacer 48. Unlike the conveyance roller pairs 61 to 67, the secondary conveyance roller 68 is constructed of a single roller coupled with no roller. A secondary image reader 69 is disposed above the slit glass 45 and disposed opposite an original conveyance path extending straight from the conveyance roller pair 63 to the secondary conveyance roller 68.

The number of the conveyance roller pairs 61 to 67 and the location thereof are arbitrarily determined based on the design of the original conveyance path 56, the length in the original conveyance direction DS of a minimum original S available in the ADF 5, and the like. According to this example embodiment, the interval between the adjacent rollers of the conveyance roller pairs 63 to 67 and the secondary conveyance roller 68 in the original conveyance direction DS is not greater than the length of a card C serving as the minimum original S available in the ADF 5 in a longitudinal direction of the card C, that is, the original conveyance direction DS.

The conveyance roller pair 61 halts the original S as the leading edge of the original S comes into contact with the conveyance roller pair 61 according to a driving time when the pickup roller 58 is driven to feed the original S to the conveyance roller pair 61, thus correcting skew of the original S. Thereafter, the conveyance roller pair 61 feeds the original S to the conveyance roller pair 62. Thus, the conveyance roller pair 61 adjusts the orientation of the leading edge of the original S.

The conveyance roller pair 67 serves as an output roller pair disposed immediately upstream from the outlet 55b in the original conveyance direction DS to eject the original S onto the output tray 53 through the outlet 55b.

The secondary image reader 69 serves as a secondary image reader that reads an image on a back side of the original S in contradistinction to a primary image reader (e.g., the image reader 4) that reads an image on a front side of the original S. The secondary image reader 69 includes a contact image sensor that reads the image on the back side of the original S or the card C before the imaging device 44 of the image reader 4 depicted in FIG. 1 reads an image on the front side of the original S or the card C.

Alternatively, like the secondary image reader 69, a single contact image sensor may be employed instead of the first carriage 41, the second carriage 42, the image forming lens 43, and the imaging device 44 depicted in FIG. 1. It is to be noted that FIG. 2 and the subsequent drawings illustrate the first carriage 41 only as a mechanism that reads the image on the original S and omit the second carriage 42, the image forming lens 43, and the imaging device 44. Similarly, a description below refers to the first carriage 41 only.

The card feeder 71 includes a card inlet 72, a card tray 73, a card pickup roller 74, and a card conveyance path 75.

The card tray 73 constitutes a part of the side wall of the cover 55 that is closed while the card C is not used. The card tray 73 is pivotable to open and close the card inlet 72.

The card pickup roller 74 feeds the card C placed on the card tray 73 to the card conveyance path 75.

The card conveyance path 75 extends from the card inlet 72 to the conveyance roller pair 63 and adjoins the original conveyance path 56 at a position upstream from the slit glass 45 in the original conveyance direction DS. For example, the card conveyance path 75 is a straight conveyance path extending from the card tray 73 to the slit glass 45 and being leveled with the upper face of the slit glass 45 so that the card conveyance path 75 and the slit glass 45 are on an identical plane.

FIG. 3 is a partial perspective view of the ADF 5. As shown in FIG. 3, according to this example embodiment, the card feeder 71 is disposed at substantially a center of the cover 55 in a main scanning direction DM perpendicular to a card conveyance direction DC.

A description is provided of a configuration of sensors incorporated in the ADF 5.

As shown in FIG. 2, the ADF 5 includes a first original length sensor 81A, a second original length sensor 81B, and a third original length sensor 81C mounted on the original tray 51 to detect the orientation (e.g., a portrait orientation or a landscape orientation) of the original S placed on the original tray 51. The first original length sensor 81A, the second original length sensor 81B, and the third original length sensor 81C are spaced apart from each other in the original conveyance direction DS.

The first original length sensor 81A is disposed in proximity to the inlet 55a and the second lateral edge of the original tray 51 in the direction perpendicular to the original conveyance direction DS that is disposed opposite the side guide plate 54. For example, the first original length sensor 81A, together with a sensor for detecting the distance from the first lateral edge of the original tray 51 and the side guide plate 54, detects that the original S placed on the original tray 51 is the card C.

The second original length sensor 81B and the third original length sensor 81C, together with a sensor for detecting the distance from the first lateral edge of the original tray 51 to the side guide plate 54, detects the size of the original S placed on the original tray 51.

If the first original length sensor 81A detects that the original S has a width equivalent to a length of an A4 size sheet in a longitudinal direction thereof, the second original length sensor 81B detects the original S, and the third original length sensor 81C does not detect the original S, an ADF controller determines that the original S is the A4 size sheet in the landscape orientation. For example, the ADF controller (e.g., a processor) is a central processing unit (CPU) provided with a random-access memory (RAM) and a read-only memory (ROM).

Conversely, if the first original length sensor 81A detects that the original S has a width equivalent to the length of the A4 size sheet in the longitudinal direction thereof and the second original length sensor 81B and the third original length sensor 81C detect the original S, the ADF controller determines that the original S is an A3 size sheet in the portrait orientation.

Determination of the size and the orientation of the originals S having the size and the orientation described above is omitted. A reflection sensor that optically detects the original S without contacting the original S or a contact sensor such as a contact actuator that detects the original S by contacting the original S is employed as the second original length sensor 81B and the third original length sensor 81C.

In proximity to a lower face of the leading end of the original tray 51 is an original set sensor 82 that detects the original S placed on the original tray 51 by detecting a tip of the set feeler 57 at a lower end of a trajectory of the set feeler 57 pivoted by the original S.

For example, when the original set sensor 82 detects the tip of the set feeler 57 separately from detection of the size and the orientation of the original S described above, that is, when the original S pivots the tip of the set feeler 57, the ADF controller determines that the original S is placed on the ADF 5.

Conversely, when the original set sensor 82 does not detect the tip of the set feeler 57, that is, when the original S does not pivot the tip of the set feeler 57, the ADF controller determines that the original S is not placed on the ADF 5. The original set sensor 82 is mounted on the original tray 51 or the original conveyer 52.

Below the leading end of the leading original tray 51A is a home position sensor 83. For example, a state in which the original S is not placed on the original tray 51, that is, a state in which the pickup roller 58 contacts the leading original tray 51A directly, defines a home position. An interval produced between the home position sensor 83 and the leading original tray 51A at the home position defines a referential interval. When the home position sensor 83 detects the referential interval, the ADF controller determines that the leading original tray 51A is at the home position.

The original conveyer 52 further includes a feed position sensor 84, an abutment sensor 85, an original width sensor 86, an entry sensor 87, a registration sensor 88, and an ejection sensor 89 that are arranged in this order in the original conveyance direction DS.

The feed position sensor 84 is situated above the leading end of the leading original tray 51A to detect the original S conveyed through the original conveyance path 56. The feed position sensor 84 detects whether or not the leading edge of the original S in the original conveyance direction DS placed on the original tray 51 is at an appropriate position, that is, an appropriate height.

The abutment sensor 85 is interposed between the feed roller 59 and the conveyance roller pair 61 in the original conveyance direction DS. When the abutment sensor 85 detects the leading edge and the trailing edge of the original S, a control circuit determines the length of the original S in the original conveyance direction DS based on a motor pulse corresponding to a conveyance distance of the original S.

The original width sensor 86 is interposed between the conveyance roller pairs 61 and 62 in the original conveyance direction DS. The original width sensor 86 includes a plurality of light-emitting elements arranged in a width direction of the original S perpendicular to the original conveyance direction DS and a plurality of light-receiving elements disposed opposite the plurality of light-emitting elements via the original conveyance path 56. The ADF controller determines the width of the original S based on a detection result from the light-receiving elements.

The entry sensor 87, the registration sensor 88, and the ejection sensor 89 detect the conveyance distance, the conveyance speed, and the like of the original S to control conveyance of the original S, jamming of the original S, and the like. The entry sensor 87 is in the original conveyance path 56 at a position interposed between the conveyance roller pairs 62 and 63 in the original conveyance direction DS. The registration sensor 88 is situated in proximity to a downstream end of the original conveyance path 56 at a position interposed between the conveyance roller pair 63 and the secondary image reader 69 in the original conveyance direction DS. The ejection sensor 89 is in the original conveyance path 56 at a position interposed between the conveyance roller pairs 66 and 67 in the original conveyance direction DS.

Alternatively, the main controller for controlling an operation of the MFP 1, instead of the ADF controller, may control driving of the components described above of the ADF 5 partially or entirely. The control performed by the ADF controller with the sensors described above is one example and therefore is not peculiar to this example embodiment.

Accordingly, general technologies may be applied to the arrangement, function, and control of the sensors and therefore other examples of the control performed by the ADF controller are omitted.

A description is provided of a configuration of a comparative image scanner. The comparative image scanner includes a primary image reader to read an image on a front side of an original and a secondary image reader disposed on an original conveyance path inside an auto document feeder (ADF) to read an image on a back side of the original. Thus, the comparative image scanner reads the image on each of the front side and the back side of the original while the original is conveyed through the single original conveyance path.

If the original conveyance path extends straight from an inlet of the original placed on an original tray to an output tray onto which the original is ejected, the comparative image scanner reads the image on the originals of various types. For example, the comparative image scanner conveys a thick original such as resin cards including a driver's license card, a cash card, and an identification card.

Alternatively, the ADF may include a primary outlet through which a regular original (e.g., plain paper) is ejected onto the output tray and a secondary outlet through which a small original such as a business card is ejected onto the output tray. Thus, the comparative image scanner, even if it incorporates the secondary image reader, reads an image on each of the front side and the back side of the small original while the small original is conveyed through the single original conveyance path.

However, the ADF is designed to convey a large original with a compact structure of the ADF. For example, the original tray and the output tray are layered partially with an interval therebetween and the original conveyance path is partially curved to produce a curved conveyance path. Accordingly, addition of extra parts is restricted.

The regular original defines an original that can be conveyed through the curved conveyance path, that is, an original having the size in a given range of from a decreased size (e.g., a postcard size) to an increased size (e.g., an A4 size in the landscape orientation and an A3 size in the portrait orientation). The decreased size includes a business card size. However, the decreased size may include other sizes smaller than a regular size.

The business card, although it is thicker than plain paper, is conveyed through the curved conveyance path if the curved conveyance path bends the business card slightly. Conversely, the thick resin cards such as the driver's license card, the cash card, and the identification card, although they are identical to the business card in size, do not bend. Further, the thick resin cards include an IC card embedded with an IC chip that prohibits bending. Accordingly, if the original conveyance path that conveys the original from the original tray to the output tray is curved and a secondary conveyance roller disposed in proximity to the image reader presses the original against an exposure glass, the thick resin cards may not be conveyed to the output tray.

Alternatively, if the inlet is situated lower than the outlet, the output tray may hinder a user from placing the small original such as the business card and the resin card on the original tray.

If the user does not place the small original on the original tray precisely, the small original may be jammed or skewed. Accordingly, the comparative image scanner may not read the image on the original of various sizes and types while being downsized and shortening a reading time taken to read the image on the original.

Additionally, an increased number of conveyance roller pairs is needed to convey the small original through the original conveyance path.

To address this circumstance, the secondary conveyance roller may be added. However, since the exposure glass is below the secondary conveyance roller, the secondary conveyance roller may not be paired with another roller unlike other conveyance roller pairs, each of which forms a nip between two rollers, to nip and feed the small original.

To address this circumstance, the secondary conveyance roller may press the small original against the exposure glass to attain a conveyance force to convey the small original.

However, while the small original is absent, the secondary conveyance roller may be pressed against the exposure glass as the secondary conveyance roller rotates, scratching the exposure glass and suffering from abrasion.

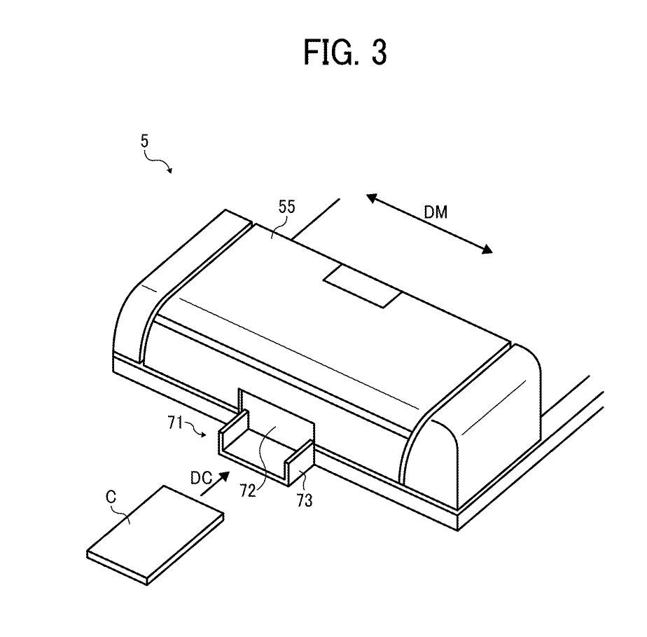

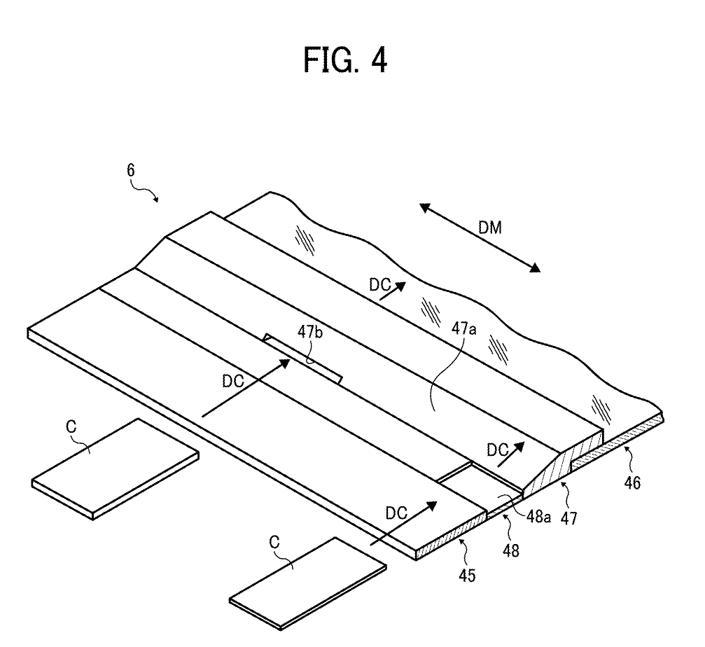

With reference to FIGS. 4, 5, 6A, 6B, 7A, 7B, 8A, and 8B, a description is provided of a first example embodiment of this disclosure.

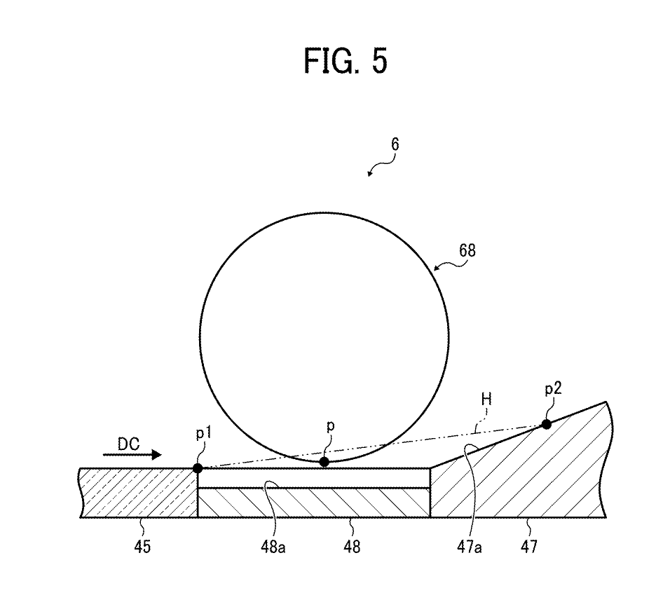

FIG. 4 is a partial perspective view of the image scanner 6. FIG. 5 is a partial vertical sectional view of the image scanner 6. According to the first example embodiment, the image scanner 6 incorporated in the MFP 1 having the basic construction described above with reference to FIG. 1 reads an image on a card C, serving as an original having a decreased size, conveyed through an original conveyance path varying depending on the type of the card C.

If the card C is a thick card, such as a business card, that is thicker than generally used paper (e.g., plain paper) or a bendable card, the card C is conveyed through the curved original conveyance path 56 to the slit glass 45 as shown in FIG. 2. Conversely, if the card C is an unbendable card for which bending is difficult or prohibited, such as a cash card, a credit card, and a driver's license card, the card C is conveyed through the card feeder 71 to the slit glass 45 as shown in FIG. 3.

As shown in FIG. 4, the stopper 47 includes a slope 47a and a slit 47b penetrating through the stopper 47. The slit 47b is situated at a center of the stopper 47 in the main scanning direction DM, that is, on a hypothetical extension of the card feeder 71 shown in FIG. 3. The unbendable thick card C such as a cash card (hereinafter referred to as the thick card C) is conveyed through the slit 47b.

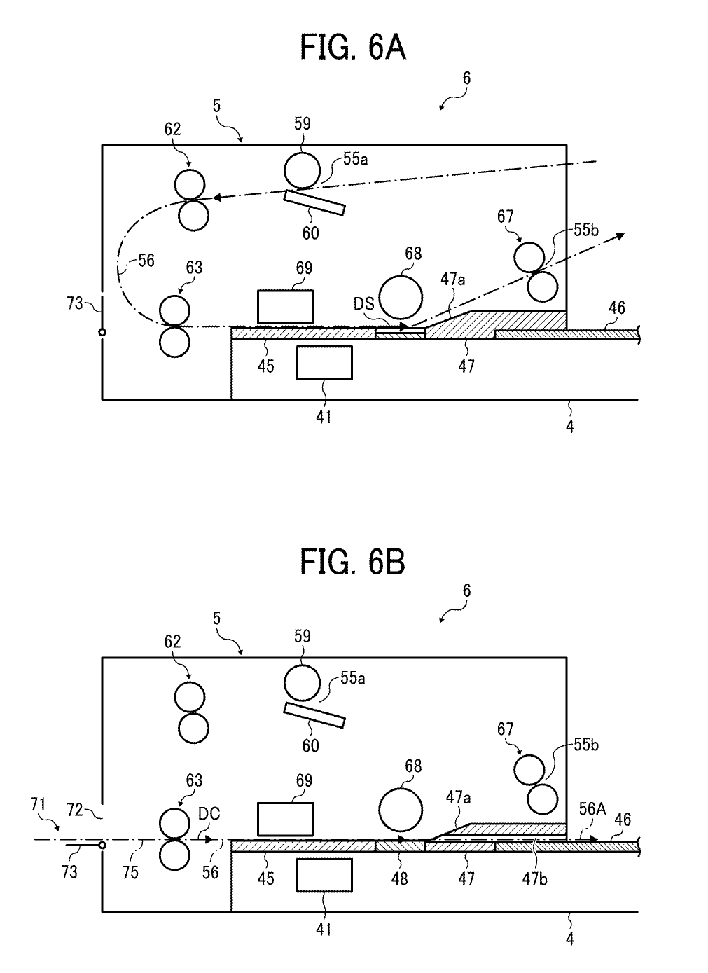

FIG. 6A is a partial vertical sectional view of the image scanner 6 illustrating conveyance of the original S through the curved original conveyance path 56. FIG. 6B is a partial vertical sectional view of the image scanner 6 illustrating conveyance of the card C through the card feeder 71. As shown in FIG. 6B, the original conveyance path 56 includes a card conveyance path 56A extending from the upper face of the slit glass 45 to the upper face of the exposure glass 46 through the slit 47b and branched from the conveyance path extending to the outlet 55b shown in FIG. 2.

As shown in FIG. 4, the spacer 48 includes a recess 48a at one lateral end of the spacer 48 in the main scanning direction DM, that is, at a hypothetical extension of the second lateral end of the original tray 51 in the main scanning direction DM. The recess 48a has a width in the main scanning direction DM greater than a short length of a bendable thin card C such as a business card (hereinafter referred to as the thin card C) in a short direction thereof.

As shown in FIG. 5, the secondary conveyance roller 68 is situated above the recess 48a and has a width not greater than the width of the recess 48a in the main scanning direction DM. Alternatively, the secondary conveyance roller 68 may be divided into a plurality of rollers in the main scanning direction DM. As shown in FIG. 2, the secondary conveyance roller 68 is also situated in a region on a hypothetical extension of the card feeder 71, that is, a conveyance region where the thick card C is conveyed.

As shown in FIG. 5, the recess 48a disposed opposite an original contact point p, that is, a lowermost point, on the secondary conveyance roller 68 that comes into contact with the thin card C isolates the secondary conveyance roller 68 from the spacer 48. The card C contacts the slit glass 45 at an upstream contact point p1 disposed upstream from the secondary conveyance roller 68 in the card conveyance direction DC. The card C contacts the stopper 47 at a downstream contact point p2 disposed downstream from the secondary conveyance roller 68 in the card conveyance direction DC. The upstream contact point p1 and the downstream contact point p2 define a line segment H. The original contact point p is below the line segment H.

The slope 47a is disposed downstream from the secondary conveyance roller 68 in the card conveyance direction DC and angled upward in the card conveyance direction DC to produce the downstream contact point p2 above the original contact point p. Accordingly, the original contact point p on the secondary conveyance roller 68 is isolated from an upper face of the spacer 48 even without the recess 48a.

If the secondary conveyance roller 68 is divided into the plurality of rollers in the main scanning direction DM, the plurality of rollers is also isolated from the spacer 48. Accordingly, the original contact point p on the secondary conveyance roller 68 is isolated from the upper face of the spacer 48 with an interval not greater than a thickness of the thick card C to allow conveyance of at least the thick card C.

With the configuration of the image scanner 6 described above, before the image scanner 6 reads an image on the original S or the thin card C, the user places the original S or the thin card C on the original tray 51 and presses a start button on a control panel disposed atop the MFP 1, causing the ADF 5 to feed the original S or the thin card C to the original conveyer 52 as shown in FIG. 2.

As shown in FIG. 6A, the original S or the thin card C is conveyed from the inlet 55a to the slit glass 45 through the curved original conveyance path 56 in such a manner that the original S or the thin card C is turned at a halfway of conveyance through the original conveyance path 56.

In a reading job for reading an image on one side (e.g., the front side) of the original S or the thin card C, the first carriage 41 reads the image on the front side of the original S or the thin card C while the original S or the thin card C passes over the upper face of the slit glass 45.

In a reading job for also reading an image on another side (e.g., the back side) of the original S or the thin card C, the secondary image reader 69 reads the image on the back side of the original S or the thin card C while the original S or the thin card C passes over the upper face of the slit glass 45.

As shown in FIG. 2, after reading of the image, the original S or the thin card C is conveyed by the conveyance roller pairs 64 to 66 to the conveyance roller pair 67 that ejects the original S or the thin card C onto the output tray 53 through the outlet 55b. Conversely, the card conveyance path 75 conveys the thick card C such as an original having a decreased size and a thick resin card (e.g., a cash card, a credit card, and a driver's license card) to the original conveyance path 56.

As shown in FIG. 6B, the thick card C is conveyed over an identical plane defined by the card conveyance path 56A extending from the upper face of the slit glass 45 to the upper face of the exposure glass 46 through the slit 47b. For example, in order to read an image on the thick card C, the card tray 73 is lowered to expose the card inlet 72. The user places the thick card C on the card tray 73 and presses the start button on the control panel disposed atop the MFP 1, causing the ADF 5 to feed the thick card C to the card conveyance path 75. While the thick card C passes over the upper face of the slit glass 45, the first carriage 41 reads the image on the thick card C in a reading job for reading the image on the front side of the thick card C or the secondary image reader 69 reads the image on the back side of the thick card C in a reading job for also reading the image on the back side of the thick card C. After reading, the secondary conveyance roller 68 conveys the thick card C to the card conveyance path 56A where the thick card C passes through the slit 47b and moves to the upper face of the exposure glass 46. The thick card C halts after it passes under the secondary conveyance roller 68. Since at least a part of the thick card C is exposed onto the exposure glass 46, the user picks up the thick card C by lifting the ADF 5.

In a reading job for reading an image on a plurality of thick cards C continuously, a subsequent thick card C pushes a preceding thick card C, allowing continuous reading of the image on the plurality of thick cards C having a combined length thereof in the card conveyance direction DC that is equivalent to the length of the exposure glass 46 in the card conveyance direction DC.

A description is provided of a detailed configuration of the image scanner 6 to convey the thin and thick cards C according to the first example embodiment.

First, a detailed description is given of the configuration of the image scanner 6 to convey the thin card C.

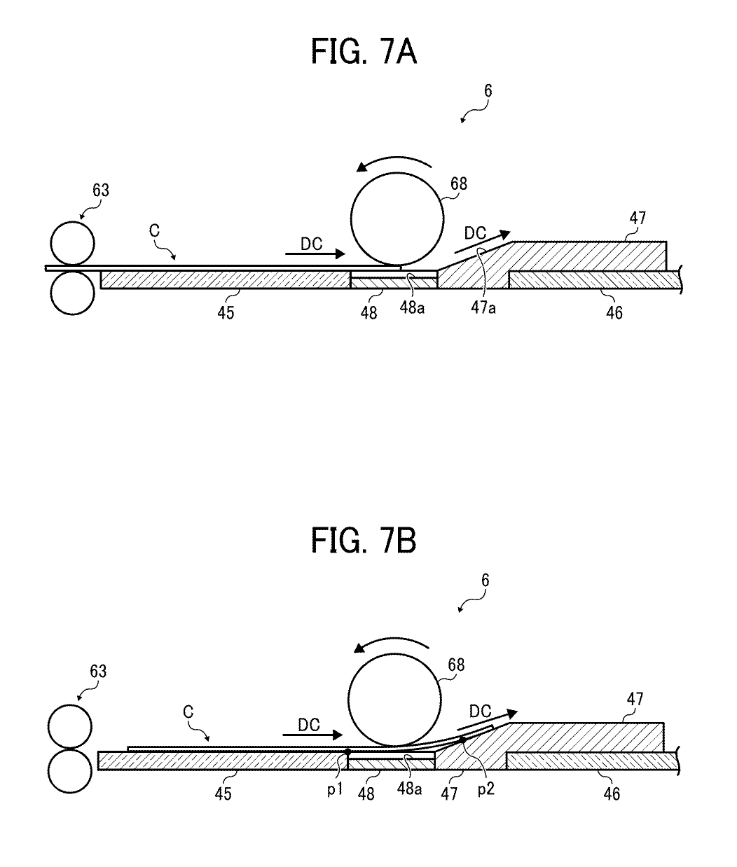

FIG. 7A is a partial vertical sectional view of the image scanner 6 illustrating the thin card C coming into contact with the secondary conveyance roller 68. As shown in FIG. 7A, the thin card C nipped by the conveyance roller pair 63, when it passes over the upper face of the slit glass 45, a leading edge, that is, a downstream edge, of the thin card C reaches the secondary conveyance roller 68. The secondary conveyance roller 68 is isolated from the upper face of the spacer 48. Accordingly, if an original S having a thickness smaller than an interval between the secondary conveyance roller 68 and the spacer 48 is used, the original S is conveyed to the conveyance roller pair 64 depicted in FIG. 2 as the original S contacts the slope 47a even if the original S is not exerted with a conveyance force from the secondary conveyance roller 68.

Conversely, if the thin card C is used, conveyance of the thin card C depends on whether or not the thin card C is exerted with the conveyance force from the secondary conveyance roller 68 according to a differential between the interval between the secondary conveyance roller 68 and the upper face of the spacer 48 and a thickness of the thin card C. Before the thin card C is ejected from a nip formed by the conveyance roller pair 63, the leading edge of the thin card C is guided by the slope 47a. Accordingly, the thin card C contacts the original contact point p on the secondary conveyance roller 68 and therefore is exerted with the conveyance force from the secondary conveyance roller 68.

FIG. 7B is a partial vertical sectional view of the image scanner 6 illustrating the thin card C exerted with an increased conveyance force from the secondary conveyance roller 68. As shown in FIG. 7B, when the leading edge of the thin card C reaches the original contact point p on the secondary conveyance roller 68, the thin card C is exerted with the increased conveyance force (e.g., a maximum conveyance force) from the secondary conveyance roller 68. After the thin card C comes into contact with the original contact point p on the secondary conveyance roller 68 and is exerted with the conveyance force from the secondary conveyance roller 68, until the thin card C moves to a position where the thin card C bridges the upstream contact point p1 and the downstream contact point p2, the thin card C is bent gradually.

Bending of the thin card C is converted into a reaction force against the secondary conveyance roller 68. Contact pressure of the thin card C pressing against the original contact point p on the secondary conveyance roller 68 is increased as the conveyance distance of the thin card C increases, thus gradually increasing the conveyance force exerted to the thin card C. When the thin card C enters a nip formed by the respective conveyance roller pairs 61 to 67, the conveyance force is transmitted from the conveyance roller pairs 61 to 67 to the thin card C as the thin card C is nipped by the respective conveyance roller pairs 61 to 67. Accordingly, as pressure exerted to the thin card C increases, the thin card C is more susceptible to a shock exerted thereto when the thin card C enters the nip of the respective conveyance roller pairs 61 to 67, a linear velocity differential between the linear velocity of the upstream conveyance roller pairs 61 to 66 and the linear velocity of the downstream conveyance roller pair 67, and the like, resulting in shock jitter that may appear on a toner image formed on a recording medium P according to image data produced by reading the image on the thin card C.

Conversely, the secondary conveyance roller 68 does not produce a nip and is isolated from the opposed spacer 48 serving as a conveyance face that contacts the thin card C and assists conveyance of the thin card C. Accordingly, the thin card C is exerted with initial decreased pressure when the thin card C comes into contact with the original contact point p on the secondary conveyance roller 68 due to the thickness of the thin card C.

As the thin card C is conveyed farther and guided by the slope 47a, the thin card C is bent and exerted with pressure that increases gradually. When the thin card C is ejected from the nip formed by the upstream conveyance roller pair 63, the secondary conveyance roller 68 and the slope 47a in turn convey the thin card C with a sufficient conveyance force. Accordingly, while the first carriage 41 reads the image on the thin card C, the thin card C is immune from sharp change in the conveyance force, preventing formation of a faulty toner image having shock jitter or the like.

When the secondary conveyance roller 68 does not contact the original S or the thin card C, since the original contact point p on the secondary conveyance roller 68 is isolated from the upper face of the spacer 48 disposed opposite the secondary conveyance roller 68, the secondary conveyance roller 68 reduces load imposed on the spacer 48 and suppresses abrasion and noise. The secondary conveyance roller 68 attains the conveyance force to convey the thin card C and the thick card C without an opposed roller disposed opposite the secondary conveyance roller 68 to form a nip therebetween to convey the thin card C and the thick card C.

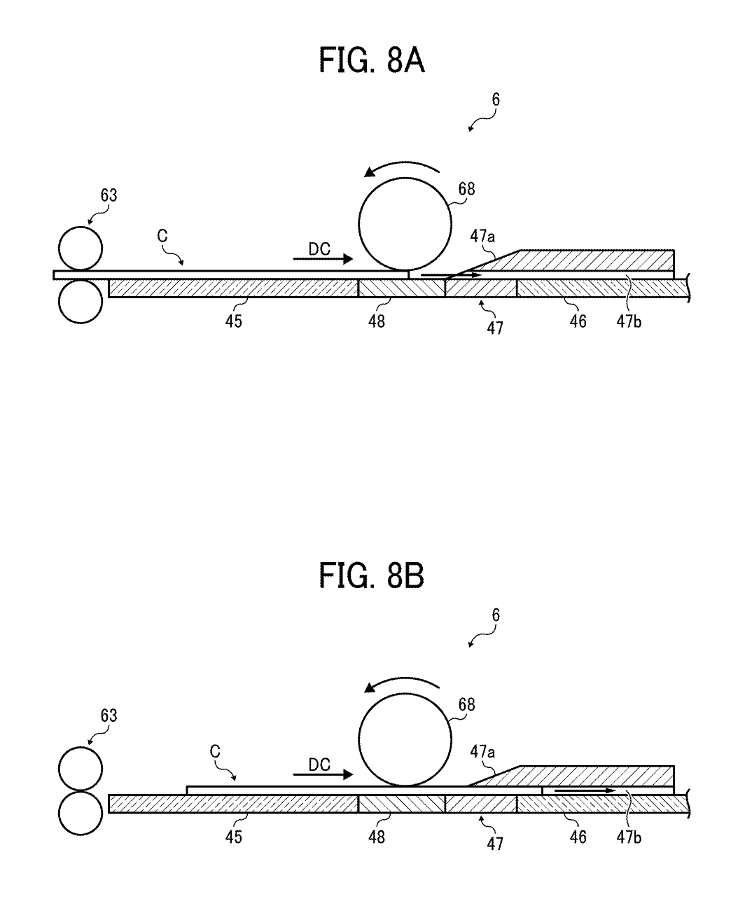

Second, a detailed description is given of the configuration of the image scanner 6 to convey the thick card C. FIG. 8A is a partial vertical sectional view of the image scanner 6 illustrating the thick card C coming into contact with the secondary conveyance roller 68. As shown in FIG. 8A, when the thick card C nipped by the conveyance roller pair 63 passes over the upper face of the slit glass 45, a leading edge, that is, a downstream edge, of the thick card C reaches the secondary conveyance roller 68. The secondary conveyance roller 68 is isolated from the upper face of the spacer 48 with an interval therebetween that is not greater than a thickness of the thick card C.

FIG. 8B is a partial vertical sectional view of the image scanner 6 illustrating the thick card C exerted with an increased conveyance force from the secondary conveyance roller 68. As shown in FIG. 8B, the thick card C having the thickness greater than the interval between the secondary conveyance roller 68 and the spacer 48 is conveyed by the secondary conveyance roller 68 and passes through the slit 47b, reaching the upper face of the exposure glass 46.

As described above and shown in FIG. 2, the image scanner 6 includes the inlet 55a to receive an original S bearing an image to be read; the original conveyer 52 to convey the original S received from the inlet 55a; and the image reader 4 to read the image on the original S. The image reader 4 reads the image on the original S passing over the upper face of the slit glass 45 while the original S moves over the slit glass 45 disposed inside the original conveyer 52. Alternatively, if the original S is placed on the exposure glass 46 disposed outside the original conveyer 52, the image reader 4 reads the image on the original S stationarily placed on the exposure glass 46. The slit glass 45 is leveled with the exposure glass 46 such that the slit glass 45 and the exposure glass 46 are placed on an identical hypothetical plane. The spacer 48 is interposed between the slit glass 45 and the exposure glass 46 in the original conveyance direction DS. As shown in FIG. 5, the original contact point p on the secondary conveyance roller 68 that comes into contact with the original S is disposed opposite the spacer 48 with an interval therebetween. Accordingly, the image scanner 6 reads the image on the original S including thick resin cards of a decreased size, while being downsized and shortening a reading time taken to read the image on the original S. Thus, the image scanner 6 reads the image on the originals S of various sizes and types.

The configuration of the image scanner 6 is not limited to that of the first example embodiment described above and various modifications are available as described below.

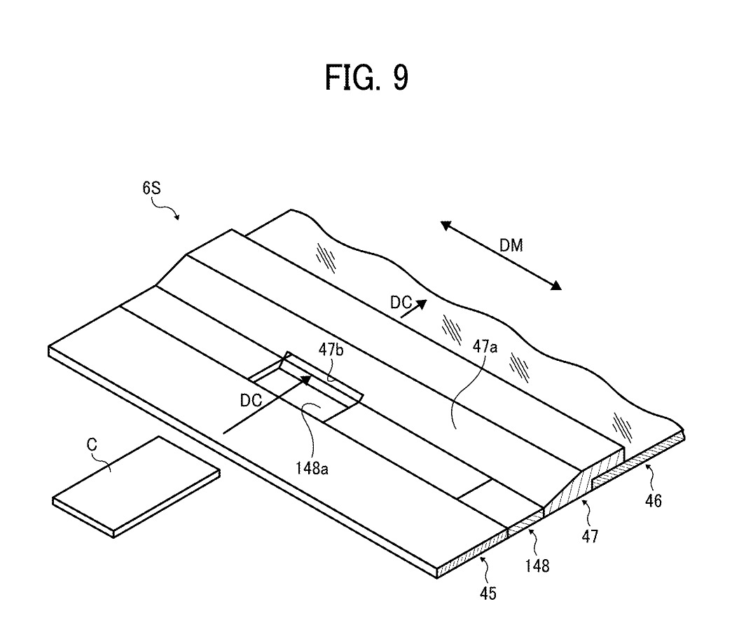

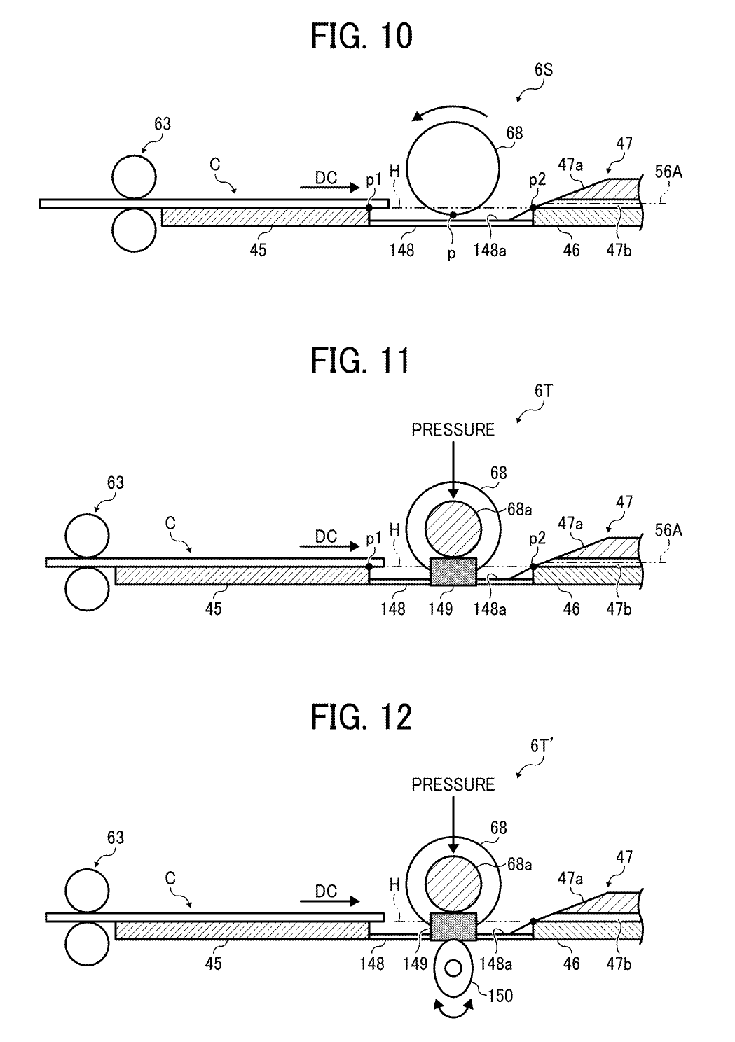

With reference to FIGS. 9 and 10, a description is provided of a second example embodiment of this disclosure.

FIG. 9 is a partial perspective view of an image scanner 6S according to the second example embodiment. FIG. 10 is a partial vertical sectional view of the image scanner 6S. The second example embodiment omits a description and a drawing of the MFP 1 equivalent to FIG. 1 and a description and a drawing of the ADF 5 equivalent to FIG. 2. Identical reference numerals are assigned to components structurally or functionally identical to the components of the first example embodiment and a detailed description of those components is omitted.

According to the second example embodiment, the image reader 4 incorporated in the MFP 1 having the basic construction described above with reference to FIG. 1 reads an image on a card C, serving as an original having a decreased size, regardless of the type of the card C or together with the configuration of the first example embodiment described above.

If the card C is a bendable thick card, such as a business card, that is thicker than generally used paper (e.g., plain paper) or a bendable thin card, the card C may be conveyed through the curved original conveyance path 56 to the slit glass 45 like in the first example embodiment as shown in FIG. 6A.

The following describes reading of an image on the card C conveyed from the card feeder 71 depicted in FIG. 3 regardless of the type of the card C. Since conveyance of the card C does not vary depending on the type of the card C, the card C denotes a thin card and a thick card unless distinction is needed.

As shown in FIG. 9, according to the second example embodiment, a spacer 148 is interposed between the slit glass 45 and the stopper 47 in the card conveyance direction DC. The spacer 148 includes a recess 148a at a center of the spacer 148 in the main scanning direction DM, that is, at a hypothetical extension of the card feeder 71 depicted in FIG. 3. The recess 148a has a width in the main scanning direction DM not smaller than the short length of the card C in the short direction thereof.

As shown in FIG. 6B, the original conveyance path 56 includes the card conveyance path 56A extending from the upper face of the slit glass 45 to the upper face of the exposure glass 46 through the slit 47b and branched from the conveyance path extending to the outlet 55b shown in FIG. 2.

As shown in FIG. 10, the secondary conveyance roller 68 is situated above the recess 148a and has a width not greater than the width of the recess 148a in the main scanning direction DM. Alternatively, the secondary conveyance roller 68 may be divided into a plurality of rollers in the main scanning direction DM.

As shown in FIG. 10, the recess 148a disposed opposite the original contact point p, that is, the lowermost point, on the secondary conveyance roller 68 that comes into contact with the card C isolates the secondary conveyance roller 68 from the spacer 148. The card C contacts the slit glass 45 at the upstream contact point p1 disposed upstream from the secondary conveyance roller 68 in the card conveyance direction DC. The card C contacts the stopper 47 at the downstream contact point p2 disposed downstream from the secondary conveyance roller 68 in the card conveyance direction DC. The upstream contact point p1 and the downstream contact point p2 define the line segment H. The original contact point p is lower than the line segment H. Hence, the original contact point p on the secondary conveyance roller 68 is lower than the upper face of each of the slit glass 45 and the exposure glass 46.

In a reading job for reading an image on the card C, the card C is conveyed through the card conveyance path 56A extending from the upper face of the slit glass 45 to the upper face of the exposure glass 46 through the slit 47b as shown in FIG. 6B. For example, in order to read the image on the card C, the card tray 73 is lowered to expose the card inlet 72. The user places the card C on the card tray 73 and presses the start button on the control panel disposed atop the MFP 1, causing the card feeder 71 to feed the card C to the card conveyance path 75.

While the card C passes over the upper face of the slit glass 45, the first carriage 41 reads the image on the card C in a reading job for reading the image on the front side of the card C or the secondary image reader 69 reads the image on the back side of the card C in a reading job for also reading the image on the back side of the card C.

After reading, the secondary conveyance roller 68 conveys the card C to the card conveyance path 56A where the card C passes through the slit 47b and moves to the upper face of the exposure glass 46. As shown in FIG. 10, the secondary conveyance roller 68 having the original contact point p lower than the upstream contact point p1 bends the card C, which generates a reaction force converted into a conveyance force which conveys the card C.

When the leading edge of the card C reaches the downstream contact point p2 by the conveyance force from the secondary conveyance roller 68, the card C is exerted with an increased conveyance force (e.g., a maximum conveyance force) from the secondary conveyance roller 68. After the card C comes into contact with the original contact point p on the secondary conveyance roller 68 and is exerted with the conveyance force from the secondary conveyance roller 68, until the card C moves to a position where the card C bridges the upstream contact point p1 and the downstream contact point p2, the card C is bent gradually.

Bending of the card C is converted into a reaction force against the secondary conveyance roller 68. Contact pressure of the card C pressing against the original contact point p on the secondary conveyance roller 68 is increased as the conveyance distance of the card C increases, thus gradually increasing the conveyance force exerted to the card C. When the secondary conveyance roller 68 does not contact the original S or the card C, since the original contact point p on the secondary conveyance roller 68 is isolated from the upper face of the spacer 148 disposed opposite the secondary conveyance roller 68, the secondary conveyance roller 68 reduces load imposed on the spacer 148 and suppresses abrasion and noise. The secondary conveyance roller 68 attains the conveyance force to convey the card C without an opposed roller disposed opposite the secondary conveyance roller 68 to form a nip therebetween to convey the card C.

With reference to FIGS. 11 and 12, a description is provided of a third example embodiment of this disclosure.

FIG. 11 is a partial vertical sectional view of an image scanner 6T according to the third example embodiment. The third example embodiment omits a description and a drawing of the MFP 1 equivalent to FIG. 1 and a description and a drawing of the ADF 5 equivalent to FIGS. 3 and 4. Identical reference numerals are assigned to components structurally or functionally identical to the components of the first and second example embodiments and a detailed description of those components is omitted.

The image scanner 6T according to the third example embodiment includes a mechanism to adjust the height of the secondary conveyance roller 68 in addition to the components of the second example embodiment. For example, as shown in FIG. 11, the image scanner 6T includes an adjuster 149 interposed between the slit glass 45 and the exposure glass 46 in the card conveyance direction DC. The adjuster 149 contacts a support shaft 68a and adjusts the height of the support shaft 68a that rotatably supports the secondary conveyance roller 68 and is movable vertically with respect to the ADF 5 in a space above the spacer 148.

The adjuster 149 changes the height of the secondary conveyance roller 68 according to the type of the card C (e.g., the thin card C or the thick card C) specified by the user with the control panel, for example.

If the thin card C is specified, the adjuster 149 moves the original contact point p on the secondary conveyance roller 68 to a first position lower than the line segment H. Conversely, if the thick card C is specified, the adjuster 149 moves the original contact point p on the secondary conveyance roller 68 to a second position lower than the line segment H and higher than the first position. Accordingly, regardless of the thickness of the card C, the adjuster 149 adjusts pressure exerted to the card C and suppresses variation in the conveyance force or the conveyance speed of the secondary conveyance roller 68 depending on the thickness of the card C.

For example, the adjuster 149 includes a solenoid or the like that changes the height of the support shaft 68a directly. Alternatively, the adjuster 149 may include an elastic member such as rubber exerted with pressure from an opposed member disposed opposite the rubber via the support shaft 68a, thus changing the height of the support shaft 68a.

A description is provided of a construction of an image scanner 6T′ as a variation of the image scanner 6T shown in FIG. 11.

FIG. 12 is a partial vertical sectional view of the image scanner 6T′. The image scanner 6T′ includes an eccentric roller 150 serving as an actuator contacting the adjuster 149 to change the height of the adjuster 149, causing the adjuster 149 to change the height of the support shaft 68a.

A recessed length of the secondary conveyance roller 68 into the recess 148a from the line segment H in a vertical direction perpendicular to the card conveyance direction DC defines a bending amount of the card C conveyed.

If the ADF 5 incorporates the adjuster 149 and the eccentric roller 150 to define the height of the secondary conveyance roller 68, the height of the secondary conveyance roller 68 is susceptible to variation caused by parts (e.g., originals S) placed on the ADF 5, operation of the user, and the like.

To address this circumstance, the secondary conveyance roller 68 presses against the adjuster 149 mounted on the image reader 4. Accordingly, even if the parts placed on the ADF 5 press down the secondary conveyance roller 68, the adjuster 149 adjusts the height of the secondary conveyance roller 68 precisely, thus facilitating management of the bending amount of the card C.

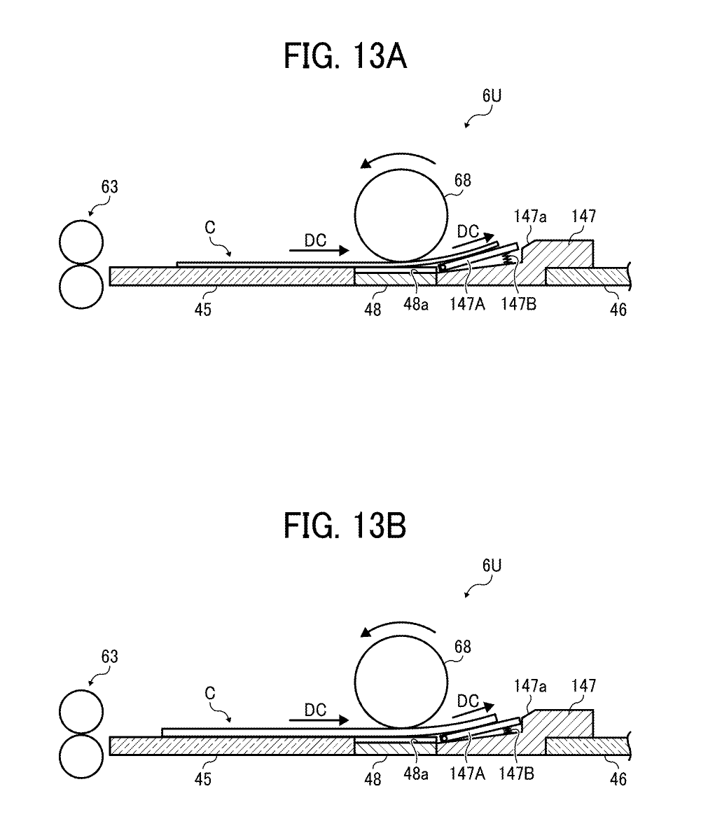

With reference to FIGS. 13A and 13B, a description is provided of a fourth example embodiment of this disclosure.

FIG. 13A is a partial vertical sectional view of an image scanner 6U according to the fourth example embodiment that conveys the thin card C. FIG. 13B is a partial vertical sectional view of the image scanner 6U that conveys the thick card C. The fourth example embodiment omits a description and a drawing of the MFP 1 equivalent to FIG. 1 and a description and a drawing of the ADF 5 equivalent to FIG. 2. Identical reference numerals are assigned to components structurally or functionally identical to the components of the first and second example embodiments and a detailed description of those components is omitted.

The image scanner 6U according to the fourth example embodiment includes a mechanism to adjust the angle of a part of the slope 47a of the stopper 47 according to the first example embodiment.

For example, a part of a slope 147a of a stopper 147 mounts a movable plate 147A and a biasing member 147B (e.g., a coil spring) to change the angle of the movable plate 147A according to the thickness and the rigidity of the card C. The movable plate 147A is pivotable about a lower end of the slope 147a. The biasing member 147B constantly biases against the movable plate 147A to angle the movable plate 147A sharply.

For example, as shown in FIG. 13A, when the thin card C is conveyed over the movable plate 147A, the movable plate 147A is angled at an increased angle (e.g., a maximum angle) to bend the thin card C. Conversely, as shown in FIG. 13B, when the thick card C is conveyed over the movable plate 147A, the movable plate 147A is angled at a decreased angle (e.g., a minimum angle) to bend the thick card C. Thus, the card C is bent variably depending on the type and the rigidity of the card C and is conveyed by an even conveyance force.

The secondary conveyance roller 68 conveys the thick card C precisely by using an increased repulsive force that the thick card C generates as it bends. Additionally, the secondary conveyance roller 68 conveys the thin card C precisely by adjusting the conveyance force to convey the thin card C by increasing an amount of bending of the thin card C that generates a decreased repulsive force as it bends.

A description is provided of advantages of the image scanners 6, 6S, 6T, 6T′, and 6U.

As shown in FIG. 2, an image scanner (e.g., the image scanners 6, 6S, 6T, 6T′, and 6U) includes the inlet 55a to receive an original (e.g., the original S and the card C) bearing an image to be read; the original conveyer 52 to convey the original received from the inlet 55a; and the image reader 4 to read the image on the original. The image scanner further includes a moving original reading portion (e.g., the slit glass 45) disposed inside the original conveyer 52 and a stationary original reading portion (e.g., the exposure glass 46) disposed outside the original conveyer 52. The image reader 4 reads the image on the original through the moving original reading portion while the original moves over the moving original reading portion. The image reader 4 reads the image on the original through the stationary original reading portion while the original is stationarily placed on the stationary original reading portion. The moving original reading portion is leveled with the stationary original reading portion such that the moving original reading portion and the stationary original reading portion are placed on an identical hypothetical plane. A spacer (e.g., the spacers 48 and 148) is interposed between the moving original reading portion and the stationary original reading portion in the original conveyance direction DS. As shown in FIG. 5, the original contact point p on the secondary conveyance roller 68 that comes into contact with the original is disposed opposite the spacer with an interval therebetween.

Accordingly, the image scanner incorporated in an image forming apparatus (e.g., the MFP 1 depicted in FIG. 1) reads the image on the original including thick resin cards of a decreased size, while being downsized and shortening a reading time taken to read the image on the original. Thus, the image scanner reads the image on the originals of various sizes and types.

The present disclosure has been described above with reference to specific example embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative example embodiments may be combined with each other and/or substituted for each other within the scope of the present disclosure.

What is claimed is:

1. An image scanner comprising:
a primary conveyance roller to convey an original bearing an image in an original conveyance direction;
an image reader disposed downstream from the primary conveyance roller in the original conveyance direction to read the image on the original;
a moving original reading portion disposed opposite the image reader, the moving original reading portion through which the image reader reads the image on the original while the original moves over the moving original reading portion;
a slope disposed downstream from the moving original reading portion in the original conveyance direction;
a spacer interposed between the moving original reading portion and the slope in the original conveyance direction; and
a secondary conveyance roller having an original contact point to come into contact with the original, the original contact point disposed opposite the spacer with an interval therebetween.

2. The image scanner according to claim 1, further comprising a stationary original reading portion disposed downstream from the moving original reading portion in the original conveyance direction and leveled with the moving original reading portion, the stationary original reading portion through which the image reader reads the image on the original while the original is stationarily placed on the stationary original reading portion.

3. The image scanner according to claim 1, wherein the moving original reading portion has an upstream contact point disposed upstream from the secondary conveyance roller in the original conveyance direction to come into contact with the original.

4. The image scanner according to claim 3,
wherein the slope has a downstream contact point disposed downstream from the secondary conveyance roller in the original conveyance direction to come into contact with the original, and
wherein, as the original bridges the upstream contact point and the downstream contact point, the original contact point on the secondary conveyance roller contacts the original to exert a conveyance force to the original.

5. The image scanner according to claim 4, wherein the upstream contact point and the downstream contact point define a line segment below which the original contact point on the secondary conveyance roller is situated.

6. The image scanner according to claim 5, wherein the slope is angled upward in the original conveyance direction such that the downstream contact point is above the original contact point to bring the original contact point on the secondary conveyance roller into contact with the original with pressure that increases as a conveyance distance of the original conveyed by the secondary conveyance roller increases.

7. The image scanner according to claim 1, further comprising:
a movable plate pivotally mounted on the slope; and
a biasing member to bias against the movable plate to change an angle of the movable plate.

8. The image scanner according to claim 1, further comprising:
a support shaft rotatably supporting the secondary conveyance roller and movable with respect to the spacer; and
an adjuster interposed between the moving original reading portion and the slope in the original conveyance direction, the adjuster contacting the support shaft to adjust a height of the support shaft.

9. The image scanner according to claim 8, wherein the adjuster includes a solenoid.

10. The image scanner according to claim 8, further comprising an actuator contacting the adjuster to change a height of the adjuster.

11. The image scanner according to claim 10, wherein the actuator includes an eccentric roller.

12. The image scanner according to claim 1, wherein the spacer includes a recess disposed opposite and isolated from the original contact point on the secondary conveyance roller.

13. The image scanner according to claim 12, wherein the recess is disposed at one lateral end of the spacer in a direction perpendicular to the original conveyance direction.

14. The image scanner according to claim 12, wherein the recess is disposed at a center of the spacer in a direction perpendicular to the original conveyance direction.

15. The image scanner according to claim 1, further comprising a stopper disposed downstream from the secondary conveyance roller in the original conveyance direction, the stopper including the slope.

16. The image scanner according to claim 15, wherein the stopper further includes a slit through which the original is conveyed.

17. The image scanner according to claim 1, wherein the original includes a card having a decreased size and an increased rigidity.

18. An image forming apparatus comprising:
an image forming device to form a toner image on a recording medium according to image data; and
an image scanner to read an image on an original to produce the image data to be sent to the image forming device,
the image scanner including:
a primary conveyance roller to convey the original bearing the image in an original conveyance direction;
an image reader disposed downstream from the primary conveyance roller in the original conveyance direction to read the image on the original;
a moving original reading portion disposed opposite the image reader, the moving original reading portion through which the image reader reads the image on the original while the original moves over the moving original reading portion;
a slope disposed downstream from the moving original reading portion in the original conveyance direction;
a spacer interposed between the moving original reading portion and the slope in the original conveyance direction; and
a secondary conveyance roller having an original contact point to come into contact with the original, the original contact point disposed opposite the spacer with an interval therebetween.
